(19) United States
(12) Patent Application Publication
(10) Pub. No.: US 2022/0297492 A1
(43) Pub. Date: Sep. 22, 2022

(54) SUSPENSION THRUST ASSEMBLY

(71) Applicant: Aktiebolaget SKF, Göteborg (SE)

(72) Inventors: Hui Zhou, Shanghai (CN); Qing Xie, Shanghai (CN); Christophe Houdayer, Semblancay (FR); Francois De Lemps, Saint-Cyr-sur-Loire (FR)

(21) Appl. No.: 17/683,411

(22) Filed: Mar. 1, 2022

(30) Foreign Application Priority Data
Mar. 22, 2021 (CN) 202110300621.1

(51) Int. Cl. B60G 15/06

(52) U.S. Cl. CPC B60G 15/068; B60G 2204/418

(57) ABSTRACT

A suspension thrust assembly, the suspension thrust assembly including a damping component and a rigid component, the damping component being overmolded and formed to the rigid component; the damping component including a damping radial portion; the rigid component including a rigid radial portion; where a ring-shaped damping component protrusion is provided on the damping radial portion, a ring-shaped rigid component groove is provided on the rigid radial portion, and the damping component protrusion is fitted in the rigid component groove.

### CROSS-REFERENCE TO RELATED APPLICATIONS

This application claims priority to Chinese Patent Application no. 202110300621.1, filed Mar. 22, 2021, the contents of which is fully incorporated herein by reference.

### TECHNICAL FIELD

The present disclosure relates to a suspension thrust assembly, and in particularly, to a suspension thrust assembly including a damping component and a rigid component.

### BACKGROUND

In the prior art, a suspension thrust assembly is made by combining a damping component and a rigid component through a process of injection and molding, where a contact bonding surface of the damping component and the rigid component is a flat surface. However, due to a force exerted by a suspension spring on the damping component, the damping component will be deformed, thereby causing the damping component to generate radial displacement relative to the rigid component, which increases the risk that the damping component and the rigid component may be partially detached.

### SUMMARY

In order to solve one or more deficiencies in the prior art, a suspension thrust assembly is proposed according to one aspect of the present disclosure, the suspension thrust assembly includes a damping component and a rigid component, and the damping component is overmolded and formed to the rigid component.

The damping component includes a damping radial portion.

The rigid component includes a rigid radial portion.

A ring-shaped damping component protrusion is provided on the damping radial portion.

A ring-shaped rigid component groove is provided on the rigid radial portion.

The damping component protrusion is fitted in the rigid component groove.

This fitting relationship increases a contact bonding area between the damping component and the rigid component. When a suspension spring of the suspension thrust assembly acts on the rigid component through the damping component, the rigid component groove allows more expansion of the damping component to be retained, which can reduce the risk of the damping component detaching from the rigid component.

According to the above aspect of the present disclosure, a plurality of groove bosses and/or a plurality of groove blind holes are provided on a bottom of the rigid component groove.

A plurality of damping component bosses and/or a plurality of damping component blind holes are provided on a top of the damping component protrusion.

The plurality of damping component bosses are fitted with the corresponding plurality of groove blind holes, and/or the plurality of damping component blind holes are fitted with the corresponding plurality of groove bosses.

According to the above various aspects of the present disclosure, a plurality of groove bosses and a plurality of groove blind holes are provided on the bottom of the rigid component groove, and a plurality of damping component bosses and a plurality of damping component blind holes are provided on the top of the damping component bosses.

The plurality of groove bosses and the plurality of groove blind holes are provided spaced apart from each other and staggered relative to each other along a circumference of the rigid component groove.

The plurality of damping component bosses and the plurality of damping component blind holes are provided spaced apart from each other and staggered relative to each other along a circumference of the damping component protrusion.

According to the above various aspects of the present disclosure, the damping component includes a damping axial portion.

The rigid component includes a rigid axial portion.

One of the damping axial portion and the rigid axial portion is provided with a plurality of stepped bosses spaced apart from each other, and the other is provided with a plurality of stepped through holes spaced apart from each other.

The plurality of stepped bosses are fitted in the corresponding plurality of stepped through holes.

The fitting of the stepped bosses of the plurality of damping components with the corresponding stepped through holes of the plurality of rigid components can prevent the displacement of the damping component relative to the rigid component in the axial direction and the radial direction.

According to another aspect of the present disclosure, at least one ring-shaped groove convex rib and/or at least one ring-shaped groove concave rib are provided on the bottom of the rigid component groove.

At least one ring-shaped damping component convex rib and/or at least one ring-shaped damping component concave rib are provided on the top of the damping component protrusion.

The damping component convex rib is fitted with the corresponding groove concave rib, and/or the damping component concave rib is fitted with the corresponding groove convex rib.

According to another aspect of the present disclosure, at least one ring-shaped groove convex rib and at least one ring-shaped groove concave rib are provided on the bottom of the rigid component groove, and at least one ring-shaped damping component convex rib and at least one ring-shaped damping component concave rib are provided on the top of the damping component protrusion.

The groove convex rib and the groove concave rib are provided spaced apart from each other and staggered relative to each other along the circumference of the rigid component groove.

The damping component convex rib and the damping component concave rib are provided spaced apart from each other and staggered relative to each other along the circumference of the damping component protrusion.

According to the above another aspect of the present disclosure, the damping component includes a damping axial portion.

The rigid component includes a rigid axial portion.

One of the damping axial portion and the rigid axial portion is provided with a plurality of bumps spaced apart from each other, and the other is provided with a plurality of recesses spaced apart from each other.

The plurality of bumps are fitted in the corresponding plurality of recesses.

The fitting of the bumps of the plurality of damping components with the corresponding recesses of the plurality of rigid components can prevent the displacement of the damping component relative to the rigid component in the axial direction and the rotation of the damping component relative to the rigid component.

According to the above another aspect of the present disclosure, the rigid component is made of a rigid plastic material.

The damping component is made of an elastic material.

According to the above another aspect of the present disclosure, the rigid component is made of a thermoplastic resin material reinforced with glass fiber.

The damping component is made of a thermoplastic polyurethane elastomer rubber.

According to the above various aspects of the present disclosure, a ring-shaped groove flange is provided on the radially outermost part of the rigid component groove.

When a suspension spring of the suspension thrust assembly acts on the damping component, the groove flange can prevent a radial elastic deformation of the damping component protrusion.

The structure according to the present disclosure avoids the axial and radial displacement of the damping component relative to the rigid component caused by the force exerted on the damping component by the suspension spring, which further avoids the risk of the damping component and the rigid component being partially detached.

So far, in order for the detailed description of the present disclosure to be better understood, and for the contribution of the present disclosure to the prior art to be better recognized, the present disclosure has summarized the content of the present disclosure quite extensively. Of course, implementation manners of the present disclosure will be described below and will form the subject of the appended claims.

Likewise, those skilled in the art will recognize that the concept on which the present disclosure is based can be easily used as a basis for designing other structures, methods, and systems for implementing several purposes of the present disclosure. Therefore, it is important that the appended claims should be considered to include such equivalent structures as long as they do not go beyond the spirit and scope of the present disclosure.

### BRIEF DESCRIPTION OF DRAWINGS

Those skilled in the art will have a better understanding of the present disclosure through the following drawings and can more clearly embody the advantages of the present disclosure. The drawings described herein are for illustrative purposes of selected embodiments only, rather than all possible implementation manners and are not intended to limit the scope of the present disclosure.

FIG. 1 shows an assembly diagram of a suspension thrust assembly according to a first implementation manner of the present disclosure;

FIG. 2 shows a space diagram of a rigid component according to the first implementation manner of the present disclosure;

FIG. 3 shows a space diagram of a damping component according to the first implementation manner of the present disclosure;

FIG. 4 shows a cross-sectional assembly diagram of the rigid component and the damping component according to the first implementation manner of the present disclosure;

FIG. 5 shows an assembly diagram of a suspension thrust assembly according to a second implementation manner of the present disclosure;

FIG. 6 shows a space diagram of a rigid component according to the second implementation manner of the present disclosure;

FIG. 7 shows a space diagram of a damping component according to the second implementation manner of the present disclosure; and

FIG. 8 shows a cross-sectional assembly diagram of the rigid component and the damping component according to the second implementation manner of the present disclosure.

### DESCRIPTION OF EMBODIMENTS

In the following, specific implementation manners according to the present disclosure will be described in detail with reference to the various drawings.

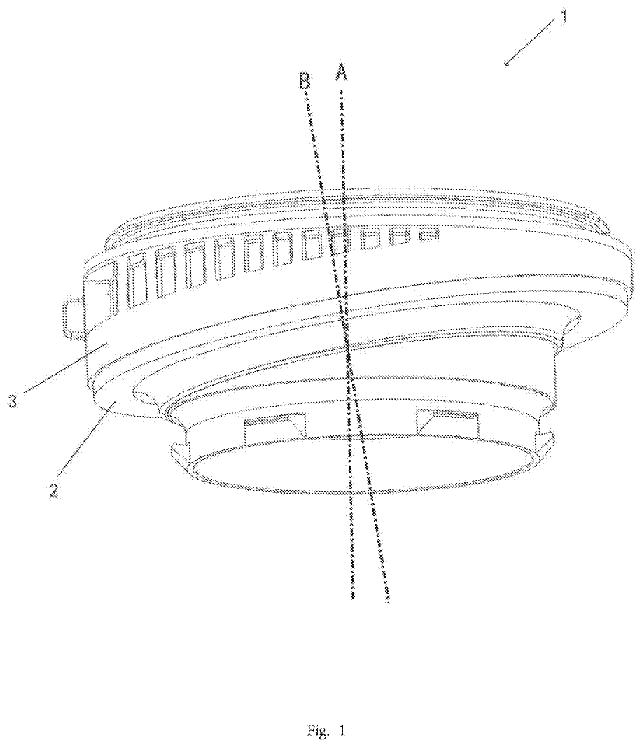

As shown in FIG. 1, a suspension thrust assembly 1 according to a first implementation manner of the present disclosure includes a damping component 2 and a rigid component 3, the damping component 2 being overmolded and formed to the rigid component 3, for example, by a process of injection and molding.

As shown in FIG. 1, the rigid component 3 has a rigid component main axis A. The damping component 2 has a damping component main axis B.

The rigid component main axis A and the damping component main axis B are at an angle with respect to each other (as shown in FIG. 1) or overlap (not shown).

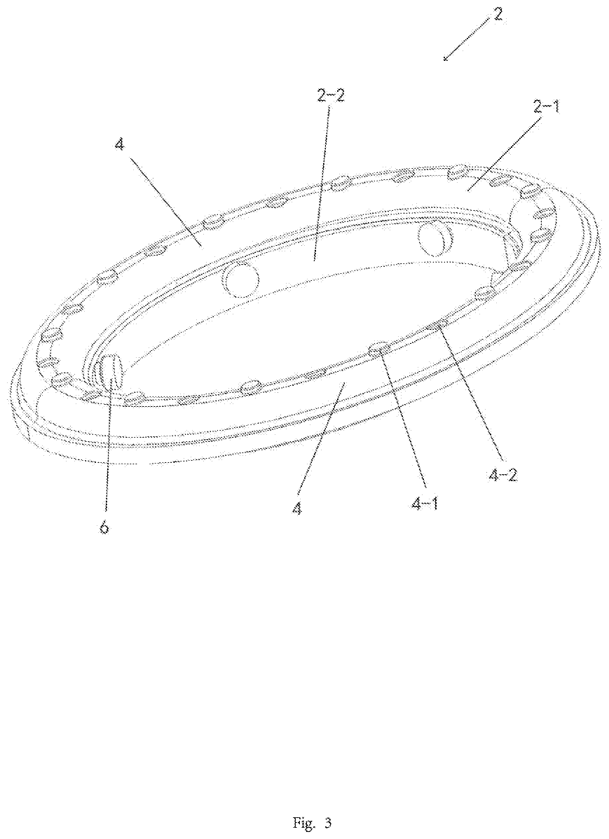

As shown in FIG. 3, the damping component 2 includes a damping radial portion 2-1.

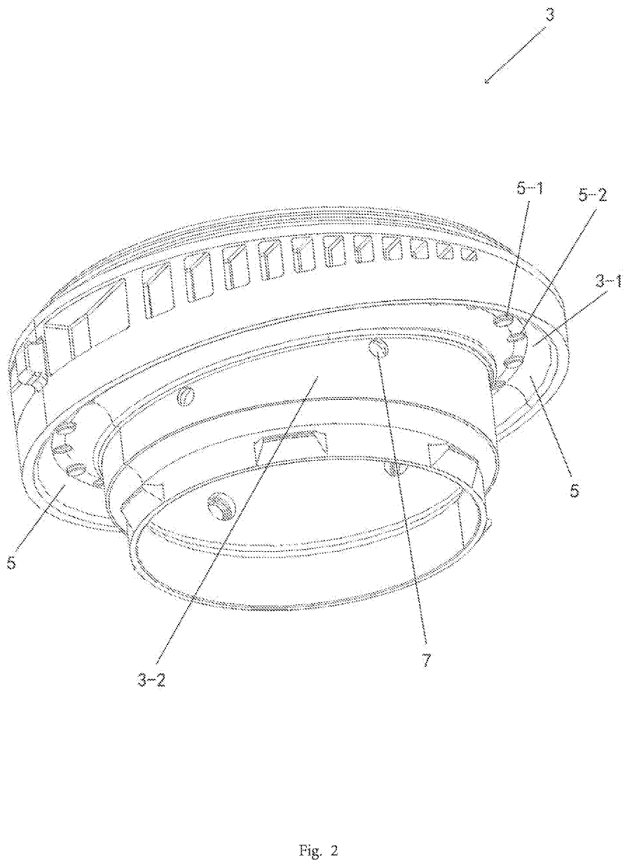

As shown in FIG. 2, the rigid component 3 includes a rigid radial portion 3-1.

A ring-shaped damping component protrusion 4 is provided on the damping radial portion 2-1. An unshown suspension spring acts on the damping radial portion 2-1.

A ring-shaped rigid component groove 5 is provided on the rigid radial portion 3-1.

The damping component protrusion 4 is fitted in the rigid component groove 5.

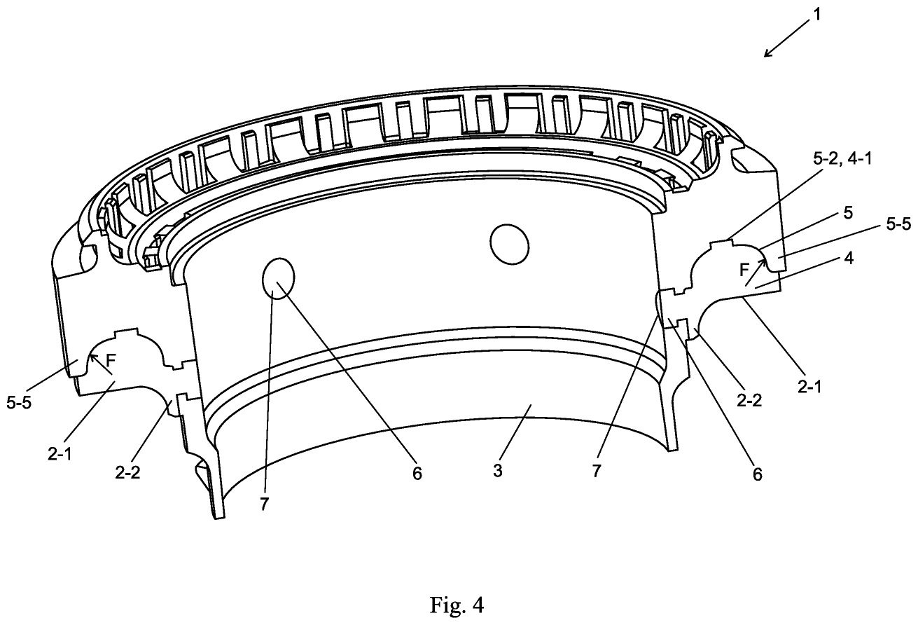

This fitting relationship increases a contact bonding area between the damping component 2 and the rigid component 3. When the suspension spring exerts a force F through the damping component 2 (see FIG. 4, where the arrow represents the direction of a resultant force exerted by the suspension spring) on the rigid component 3, the rigid component groove 5 allows more expansion of the damping component 2 to be retained, which can reduce the risk of the damping component 2 detaching from the rigid component 3.

According to the above implementation manner of the present disclosure, a plurality of groove bosses 5-1 and a plurality of groove blind holes 5-2 are provided on a bottom of the rigid component groove 5.

The plurality of groove bosses 5-1 and the plurality of groove blind holes 5-2 are provided spaced apart from each other and staggered relative to each other along a circumference of the rigid component groove 5.

According to the above various implementation manners of the present disclosure, a plurality of damping component bosses 4-1 and a plurality of damping component blind holes 4-2 are provided on a top of the damping component protrusion 4.

The plurality of damping component bosses 4-1 and the plurality of damping component blind holes 4-3 are provided spaced apart from each other and staggered relative to each other along a circumference of the damping component protrusion 4.

According to the above various implementation manners of the present disclosure, the damping component 2 and the rigid component 3 are both solid structures. For clarity, FIG. 4 shows the fitting relationship with a transparent diagram, where the plurality of damping component portion bosses 4-1 are fitted with the corresponding plurality of groove blind holes 5-2.

The plurality of damping component blind holes 4-2 are fitted with the corresponding plurality of groove bosses 5-1.

This fitting relationship further increases the contact boding area of the damping component 2 and the rigid component 3, thereby preventing the rotating of the damping component 2 relative to the rigid component 3.

As shown in FIG. 4, a ring-shaped first groove flange 5-5 is provided on the radially outermost part of the rigid component groove 5. The distance between the bottom of the rigid portion groove 5 and the first groove flange 5-5 is set such that when the suspension spring exerts the force F (see FIG. 4) on the damping portion 2, the first groove flange 5-5 can block a radial elastic deformation of the damping component protrusion 4, thereby further reducing the risk of the damping component 2 being detaching from the rigid component 3.

According to the above various implementation manners of the present disclosure, the damping component 2 includes a damping axial portion 2-2.

The rigid component 3 includes a rigid axial portion 3-2.

A plurality of stepped bosses 6 spaced apart from each other are provided on the damping axial portion 2-2.

A plurality of stepped through holes 7 spaced apart from each other are provided on the rigid axial portion 3-2.

The plurality of stepped bosses 6 are fitted in the corresponding plurality of stepped through holes 7.

The fitting of the stepped bosses 6 with the corresponding stepped through holes 7 can prevent the displacement of the damping component 2 relative to the rigid component 3 in the axial direction and the radial direction.

The foregoing disclosure provides illustration and description but is not intended to be exhaustive or to limit the implementation manners to the precise form disclosed. Modifications and variations are possible in light of the above disclosure or may be acquired from practice of the implementation manners. For example, one of bottom of the rigid component groove and the top of the damping component protrusion is only provided with a plurality of bosses, and the other is only provided with a plurality of blind holes, and the bosses are fitted with the corresponding blind holes. For another example, a plurality of stepped through holes spaced apart from each other are provided on the damping axial portion 2-2, a plurality of stepped bosses spaced apart from each other are provided on the rigid axial portion 3-2, and the like.

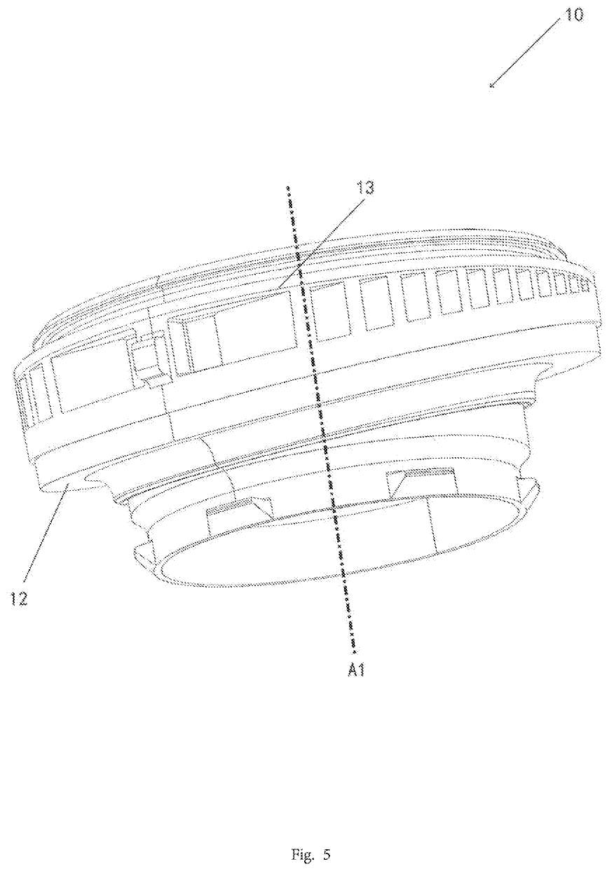

According to a second implementation manner of the present disclosure, as shown in FIG. 5, a suspension thrust assembly 10 includes a damping component 12 and a rigid component 13, the damping component 12 being overmolded and formed to the rigid component 13, for example, by the process of injection and molding.

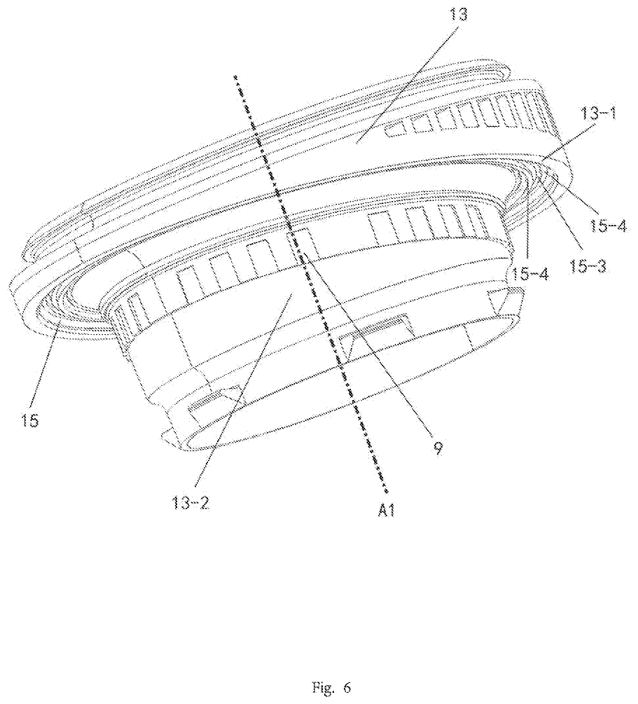

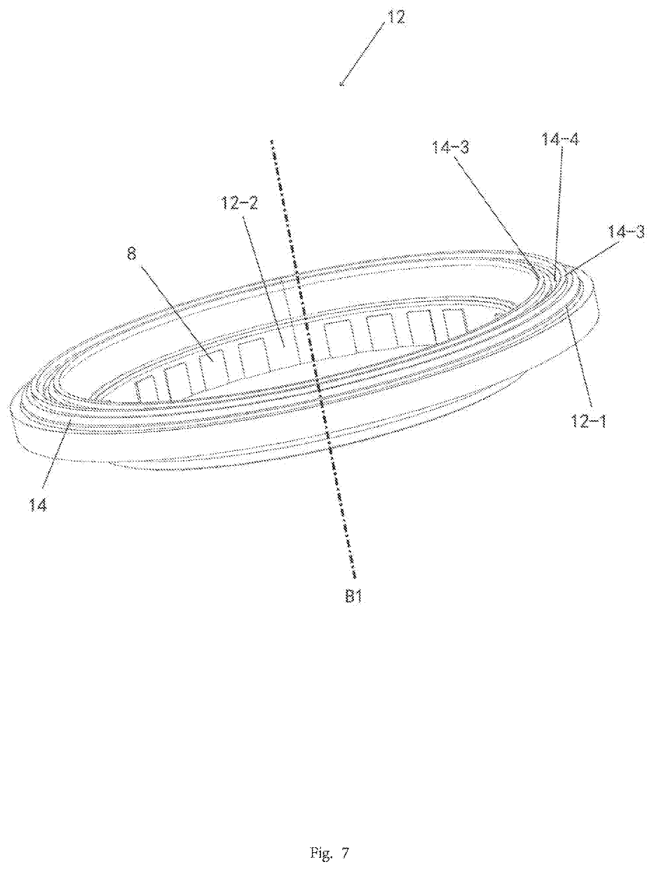

As shown in FIG. 5, the rigid component 13 has a rigid component main axis Al. As shown in FIG. 6 and FIG. 7, the damping component 12 has a damping component main axis B 1.

The rigid component main axis Al and the damping component main axis

B1 are at an angle with respect to each other or overlap (not shown).

As shown in FIG. 7, the damping component 12 includes a damping radial portion 12-1.

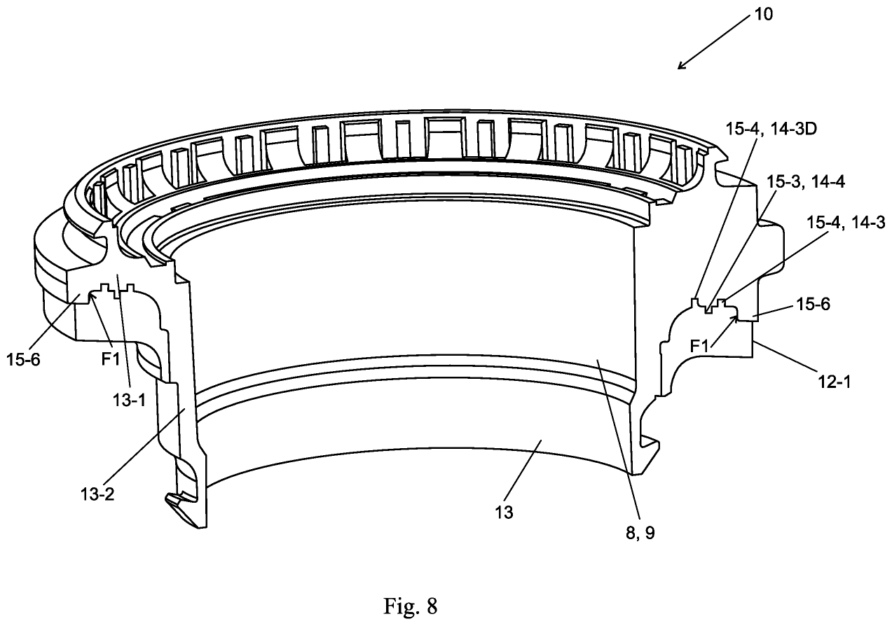

As shown in FIG. 8, the rigid component 13 includes a rigid radial portion 13-1.

A ring-shaped damping component protrusion 14 is provided on the damping radial portion 12-1. An unshown suspension spring 11 acts on the damping radial portion 12-1.

As shown in FIG. 6, a ring-shaped rigid component groove 15 is provided on the rigid radial portion 13-1.

The damping component protrusion 14 is fitted in the rigid component groove 15.

This fitting relationship increases the contact bonding area between the damping component 12 and the rigid component 13. When the suspension spring exerts a force F1 through the damping component 12 (see FIG. 8, where the arrow represents the direction of a resultant force exerted by the suspension spring) on the rigid component 13, this can reduce the risk of the damping component 12 detaching from the rigid component 13.

As shown in FIG. 6, at least one ring-shaped groove convex rib 15-3 and at least one ring-shaped groove concave rib 15-4 are provided on the bottom of the rigid component groove 15.

The groove convex rib 15-3 and the groove concave rib 15-4 are provided spaced apart from each other and staggered relative to each other along the circumference of the rigid component groove 15.

According to the above another implementation manner of the present disclosure, as shown in FIG. 7, at least one ring-shaped damping component convex rib 14-3 and at least one ring-shaped damping component concave rib 14-4 are provided on the top of the damping component protrusion 14.

The damping component convex rib 14-3 and the damping component concave rib 14-4 are provided spaced apart from each other and staggered relative to each other along the circumference of the damping component protrusion 14.

According to the above another implementation manner of the present disclosure, the damping component 12 and the rigid component 13 are both solid structures. For clarity, FIG. 8 shows a fitting relationship with a transparent diagram, where the damping component convex rib 14-3 is fitted with the corresponding groove concave rib 15-4.

The damping component concave rib 14-4 is fitted with the corresponding groove concave rib 15-3.

This fitting relationship further increases the contact boding area of the damping component 12 and the rigid component 13, thereby preventing the radial displacement of the damping component 12 relative to the rigid component 13.

A ring-shaped second groove flange 15-6 is provided on the radially outermost part of the rigid component groove 15. The distance between the bottom of the rigid portion groove 15 and the second groove flange 15-6 is set such that when the suspension spring exerts the force F (see FIG. 8) on the damping portion 12, the second groove flange 15-6 can block the radial elastic deformation of the damping component protrusion, thereby further reducing the risk of the damping component 12 being detaching from the rigid component 13.

According to the above another implementation manner of the present disclosure, the damping component 12 includes a damping axial portion 12-2.

The rigid component 13 includes a rigid axial portion 13-2.

As shown in FIG. 7, a plurality of bumps 8 spaced apart from each other are provided on the damping axial portion 12-2.

As shown in FIG. 6, a plurality of recesses 9 spaced apart from each other are provided on the rigid axial portion 13-2.

As shown in FIG. 8, the plurality of bumps 8 are fitted in the corresponding plurality of recesses 9.

The fitting of the plurality of bumps 8 and the corresponding plurality of recesses 9 can prevent the displacement of the damping component 12 relative to the rigid component 13 in the axial direction and the rotation of the damping component 12 relative to the rigid component 13.

According to the above another implement manner of the present disclosure, the rigid component 13 is made of a rigid plastic material.

The damping component 12 is made of an elastic material.

According to the above another implementation manner of the present disclosure, the rigid component 13 is made of a thermoplastic resin material reinforced with glass fiber.

The damping component 12 is made of a thermoplastic polyurethane elastomer rubber.

The foregoing disclosure provides illustration and description but is not intended to be exhaustive or to limit the implementation manners to the precise form disclosed. Modifications and variations are possible in light of the above disclosure or may be acquired from practice of the implementation manners. For example, one of the bottom of the rigid component groove and the top of the damping component protrusion is only provided with a ring-shaped convex rib, and the other is only provided with the ring-shaped concave rib, and the concave rib is fitted with the convex rib. For another example, a plurality of recesses spaced apart from each other are provided on the damping axial portion, and a plurality of bumps spaced apart are provided on the rigid axial portion.

Even though particular combinations of features are recited in the claims and/or disclosed in the specification, these combinations are not intended to limit the disclosure of various implementation manners. In fact, many of these features may be combined in ways not specifically recited in the claims and/or disclosed in the specification. Although each dependent claim listed below may directly depend on only one claim, the disclosure of various implementation manners includes each dependent claim in combination with every other claim in the claim set.

No element, act, or instruction used herein should be construed as critical or essential unless explicitly described as such. Furthermore, as used herein, the articles “a” and “an” are intended to include one or more items and may be used interchangeably with “one or more”. In addition, as used herein, the article “the” is intended to include one or more items referenced in conjunction with the article “that” and may be used interchangeably with “one or more”. Furthermore, as used herein, the term “set” is intended to include one or more items (e.g., related items, unrelated items, a combination of related and unrelated items, and the like), and may be used interchangeably with “one or more”. Where only one item is intended, the phrase “only one item” or similar language is used. Also, as used herein, the term “having” and its variants and the like are intended to be open terms. Further, the phrase “based on” is intended to mean “based at least in part on” unless explicitly stated otherwise. In addition, as used herein, the term “or” when used in tandem is intended to be inclusive and can be used interchangeably with “and/or” unless expressly stated otherwise (for example, if it is used in conjunction with “or” or “only one of them”).

1. A suspension thrust assembly, the suspension thrust assembly comprising a damping component and a rigid component, the damping component being overmolded and formed to the rigid component;
the damping component comprising a damping radial portion;
the rigid component comprising a rigid radial portion;
wherein
a ring-shaped damping component protrusion is provided on the damping radial portion,
a ring-shaped rigid component groove is provided on the rigid radial portion, and
the damping component protrusion is fitted in the rigid component groove.

2. The suspension thrust assembly according to claim 1, wherein
a plurality of groove bosses and/or a plurality of groove blind holes are provided on a bottom of the rigid component groove;
a plurality of damping component bosses and/or a plurality of damping component blind holes are provided on a top of the damping component protrusion; and
the plurality of damping component bosses are fitted with the corresponding plurality of groove blind holes, and/or the plurality of damping component blind holes are fitted with the corresponding plurality of groove bosses.

3. The suspension thrust assembly according to claim 2, wherein
a plurality of groove bosses and a plurality of groove blind holes are provided on the bottom of the rigid component groove, and a plurality of damping component bosses and a plurality of damping component blind holes are provided on the top of the damping component protrusion;
the plurality of groove bosses and the plurality of groove blind holes are provided spaced apart from each other and staggered relative to each other along a circumference of the rigid component groove; and
the plurality of damping component bosses and the plurality of damping component blind holes are provided spaced apart from each other and staggered relative to each other along a circumference of the damping component protrusion.

4. The suspension thrust assembly according to any one of claims 1 to 3, wherein
the damping component comprising a damping axial portion;
the rigid component comprising a rigid axial portion;
one of the damping axial portion and the rigid axial portion is provided with a plurality of stepped bosses spaced apart from each other, and the other is provided with a plurality of stepped through holes spaced apart from each other; and
the plurality of stepped bosses are fitted in the corresponding plurality of stepped through holes.

5. The suspension thrust assembly according to claim 1, wherein
at least one ring-shaped groove convex rib and/or at least one ring-shaped groove concave rib are provided on the bottom of the rigid component groove;
at least one ring-shaped damping component convex rib and/or at least one ring-shaped damping component concave rib are provided on the top of the damping component protrusion; and
the damping component convex rib is fitted with the corresponding groove concave rib, and/or the damping component concave rib is fitted with the corresponding groove convex rib.

6. The suspension thrust assembly according to claim 5, wherein
at least one ring-shaped groove convex rib and at least one ring-shaped groove concave rib are provided on the bottom of the rigid component groove, and at least one ring-shaped damping component convex rib and at least one ring-shaped damping component concave rib are provided on the top of the damping component protrusion;
the groove convex rib and the groove concave rib are provided spaced apart from each other and staggered relative to each other along the circumference of the rigid component groove; and
the damping component convex rib and the damping component concave rib are provided spaced apart from each other and staggered relative to each other along the circumference of the damping component protrusion.

7. The suspension thrust assembly according to claim 5 or 6, wherein
the damping component comprising a damping axial portion;
the rigid component comprising a rigid axial portion;
one of the damping axial portion and the rigid axial portion is provided with a plurality of bumps spaced apart from each other, and the other is provided with a plurality of recesses spaced apart from each other; and
the plurality of bumps are fitted in the corresponding plurality of recesses.

8. The suspension thrust assembly according to claim 1, wherein
the rigid component is made of a rigid plastic material; and
the damping component is made of an elastic material.

9. The suspension thrust assembly according to claim 8, wherein
the rigid component is made of a thermoplastic resin material reinforced with glass fiber; and
the damping component is made of a thermoplastic polyurethane elastomer rubber.

10. The suspension thrust assembly according to claim 1, wherein
a ring-shaped groove flange is provided on the radially outermost part of the rigid component groove; and
when a suspension spring of the suspension thrust assembly acts on the damping component, the groove flange can prevent a radial elastic deformation of the damping component protrusion.
